(19) United States
(12) Patent Application Publication
(10) Pub. No.: US 2010/0046213 A1
(43) Pub. Date: Feb. 25, 2010

(54) FLASHLIGHT HAVING A STRUCTURE CONFIGURED TO PROVIDE USEFUL MECHANICAL FEATURES

(76) Inventor: Paul Y. Kim, Santa Ana, CA (US)

Correspondence Address: HAYNES AND BOONE, LLP;IP Section, 2323 Victory Avenue, SUITE 700, Dallas, TX, 75219, US

(21) Appl. No.: 12/240,778

(22) Filed: Sep. 29, 2008

Related U.S. Application Data
(63) Continuation-in-part of application No. 29/323,348, filed on Aug. 22, 2008, now Pat. No. D606219.
Application No. 29/323,348 is a continuation-in-part of application No. 29/323,350, filed on Aug. 22, 2008, now Pat. No. D606686.
Application No. 29/323,350 is a continuation-in-part of application No. 29/323,351, filed on Aug. 22, 2008, now Pat. No. D606220.
Application No. 29/323,351 is a continuation-in-part of application No. 29/323,353, filed on Aug. 22, 2008, now Pat. No. D606687.

(51) Int. Cl. F21L 4/04

(52) U.S. Cl. 362/202

(57) ABSTRACT

Various structures are provided that may be advantageously used in one or more flashlight designs. In one example, apertures may be provided in a flashlight body to facilitate attachment of the flashlight with various structures. In another example, a recess may be included in an external surface of a flashlight head to facilitate the attachment of appropriate insignia or structures to a flashlight in an efficient manner that need not interfere with a user's operation of the flashlight.

### CROSS-REFERENCE TO RELATED APPLICATIONS

This application is a continuation-in-part application of U.S. Design patent application No. 29/323,348 filed Aug. 22, 2008, which is hereby incorporated by reference.

This application is also a continuation-in-part application of U.S. Design patent application No. 29/323,350 filed Aug. 22, 2008, which is hereby incorporated by reference.

This application is also a continuation-in-part application of U.S. Design patent application No. 29/323,351 filed Aug. 22, 2008, which is hereby incorporated by reference.

This application is also a continuation-in-part application of U.S. Design patent application No. 29/323,353 filed Aug. 22, 2008, which is hereby incorporated by reference.

### BACKGROUND

1. Field of the Invention

The present invention generally relates to flashlights and more particularly to flashlights with useful mechanical configurations.

2. Related Art

As is well known, flashlights are typically configured to perform only a single function, namely, to illuminate areas of interest. Conventional flashlights are therefore typically implemented with a mechanical structure directed to performing this single function. For example, such flashlights may include a generally cylindrical body that holds a power source or other related components. A head may also be attached to the cylindrical body. For example, the head may be used to hold a light source, lens, or other related components.

Unfortunately, such conventional flashlight structures have various limitations. For example, although the cylindrical body may be useful when grasped by a user's hand, such a structure can render the flashlight difficult to attach or otherwise secure to other structures. Also, although certain implementations may permit the head to be grasped and rotated by the user (e.g., to adjust the light beam provided by the flashlight), the external surface of the head in such implementations is otherwise non-functional. Accordingly, there is a need for an improved flashlight that overcomes one or more of the deficiencies discussed above.

### SUMMARY

In accordance with embodiments further described herein, various structures are provided that may be advantageously used in one or more flashlight designs. For example, in one embodiment, apertures may be provided in a flashlight body to facilitate attachment of the flashlight with various structures. In another embodiment, a recess may be included in an external surface of a flashlight head to facilitate the attachment of appropriate insignia or structures to a flashlight in an efficient manner that need not interfere with a user's operation of the flashlight. These and other features and advantages of the present invention will be more readily apparent from the detailed description of the embodiments set forth below taken in conjunction with the accompanying drawings.

### BRIEF DESCRIPTION OF THE FIGURES

FIG. 1 is a front perspective view of a flashlight with three apertures in accordance with an embodiment of the invention.

FIG. 2 is a rear perspective view of the flashlight of FIG. 1 in accordance with an embodiment of the invention.

FIG. 3 is a top plan view of the flashlight of FIG. 1 in accordance with an embodiment of the invention.

FIG. 4 is a bottom plan view of the flashlight of FIG. 1 in accordance with an embodiment of the invention.

FIG. 5 is a left side elevational view of the flashlight of FIG. 1 in accordance with an embodiment of the invention.

FIG. 6 is a right side elevational view thereof of the flashlight of FIG. 1 in accordance with an embodiment of the invention.

FIG. 7 is a front side elevational view of the flashlight of FIG. 1 in accordance with an embodiment of the invention.

FIG. 8 is a rear side elevational view of the flashlight of FIG. 1 in accordance with an embodiment of the invention.

FIG. 9 is a cross-sectional view of the flashlight of FIG. 5 taken at line A-A in accordance with an embodiment of the invention.

FIG. 10 is a cross-sectional view of the flashlight of FIG. 8 taken at line B-B in accordance with an embodiment of the invention.

FIG. 11 is a front perspective view of the flashlight of FIG. 1 showing the insertion of a plate into a recess in accordance with an embodiment of the invention.

FIG. 12 is a front perspective view of the flashlight of FIG. 1 after a plate has been inserted into a recess in accordance with an embodiment of the invention.

FIG. 13 is a front perspective view a flashlight with a clip in accordance with an embodiment of the invention.

FIG. 14 is a front perspective view of a flashlight with four apertures in accordance with an embodiment of the invention.

FIG. 15 is a front perspective view of a flashlight with two sets of three apertures in accordance with an embodiment of the invention.

FIG. 16 is a front perspective view of a flashlight with two sets of four apertures in accordance with an embodiment of the invention.

FIG. 17 is a front perspective view of a flashlight with various curved shapes in accordance with an embodiment of the invention.

Like element numbers in different figures represent the same or similar elements.

### DETAILED DESCRIPTION

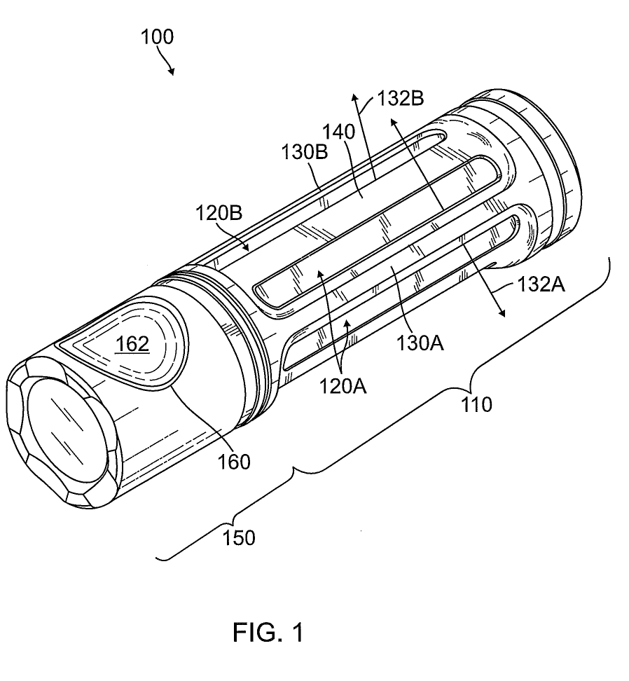

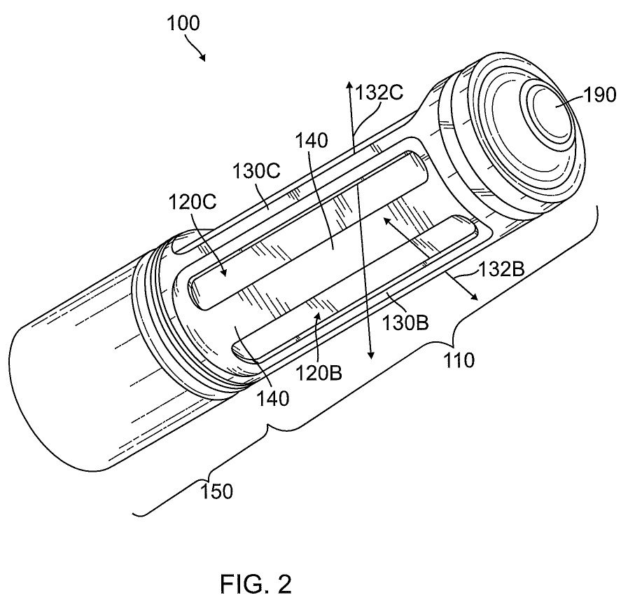

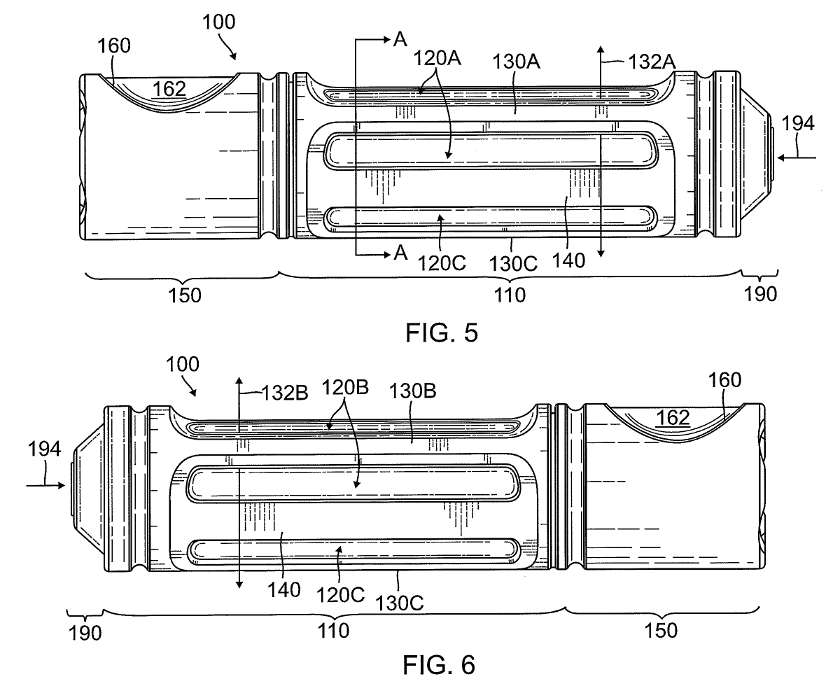

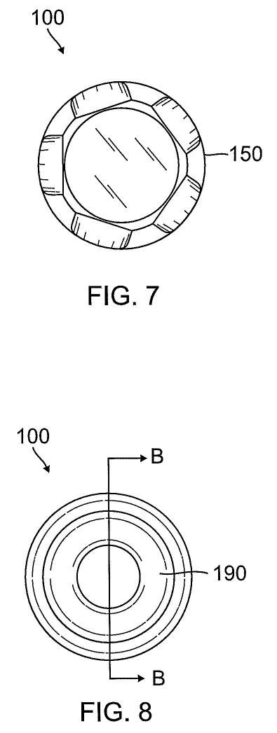

Referring now to the drawings wherein the showings are for purposes of illustrating embodiments of the present invention only, and not for purposes of limiting the same, FIGS. 1-12 illustrate a flashlight 100 in accordance with various embodiments of the invention. As shown in FIGS. 1-12, flashlight 100 includes a body 110, a head 150, and a tailcap 190. Body 110, head 150, and tailcap 190 may be implemented using any material appropriate for flashlights including, for example, metal, polymer, rubber, and/or other appropriate materials.

Body 110 may be implemented as a generally elongate structure that may be provided as a single component (e.g., created from a single piece of metal or other appropriate material) or plural components. As shown in the cross-sectional view in FIG. 10, body 110 includes a cavity 112 that may receive a battery 114 (e.g., a conventional AA battery) to provide power to appropriate circuitry 116 which is shown together with a light source 118 (e.g., a bulb, light emitting diode (LED), or other appropriate light source), and a lens assembly 119 (e.g., which may be implemented to provide total internal reflection of light from light source 118) secured in head 150.

As also shown in FIG. 10, tailcap 190 may be implemented as a switch secured to body 110. In this regard, tailcap 190 may be connected to appropriate circuitry 192 in body 110 to selectively turn flashlight 100 on and off, and/or to adjust the brightness of light provided by flashlight 100 in response to a user's operation of tailcap 190. For example, in one embodiment, tailcap 190 may be selectively pressed by a user in the direction of arrow 194 to operate flashlight 100.

As shown in FIGS. 1-12, three apertures (e.g., holes, cuts, voids, cavities, or other types of apertures) 120A-C are provided in body 110. In this regard, apertures 120A-C are extended through body 110 along axes 132A-C. Apertures 120A-C are illustrated as having substantially elongate cross-sections. Other types of apertures having different cross-sectional shapes (e.g., rectangles, squares, circles, ovals, or other shapes) are also contemplated. Moreover, although three apertures 120A-C are shown in FIGS. 1-12, any desired number of apertures may be used in other embodiments (e.g., single or plural apertures).

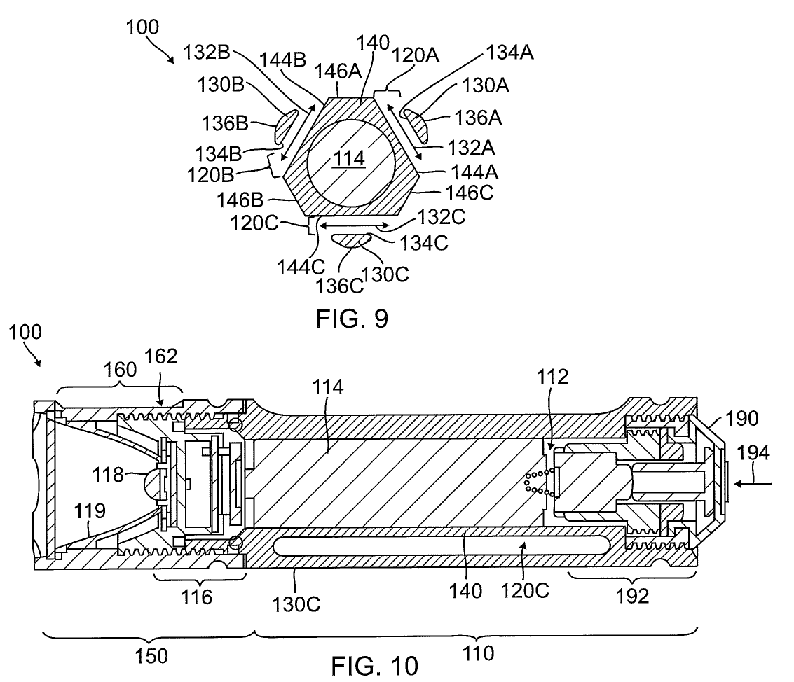

The inclusion of apertures 120A-C in body 110 results in portions of body 110 being offset from each other around apertures 120A-C. For example, as shown in the cross-sectional views provided in FIGS. 9 and 10, each of apertures 120A-C causes a corresponding bridge 130A-C of body 110 to be separated from a core 140 of body 110. Apertures 120A-C are shown as being spaced substantially equidistantly around core 140. However, asymmetric orientations of apertures 120A-C are also contemplated. Because apertures 120A-C extend through body 110, external objects may be selectively inserted into apertures 120A-C to protrude through body 110 along axes 132A, 132B, and 132C. For example, in one embodiment, flashlight 100 may be secured to another structure (e.g., a weapon, vehicle, building, a user's body, or other object or structure) by an appropriate mounting apparatus inserted into one or more of apertures 120A-C. In another embodiment, a rope, string, lanyard, or other appropriate flexible structure may inserted into one or more of apertures 120A-C and wrapped around one or more of bridges 130A-C and/or core 140 to secure flashlight 100 to such a structure (for example, to suspend flashlight 100 from a user's neck by a lanyard). It will be appreciated that any other desired object may be inserted through apertures 120A-C as may be appropriate in various applications.

Bridges 130A-C are substantially parallel with each other and extend lengthwise along body 110. In addition, inner surfaces 134A-C of bridges 130A-C, outer surfaces 144A-C of core 140, and portions of outer surfaces 136A-C of bridges 130A-C are substantially planar and parallel with each other. Also, external surfaces 146A-C of core 140 are substantially planar. Advantageously, these various planar and parallel surface arrangements can provide weight-bearing surfaces to facilitate the attachment of flashlight 100 to another structure as previously described herein.

Other shapes and surface arrangements are also contemplated. For example, in one embodiment, bridges 130A-C, inner surfaces 134A-C, outer surfaces 136A-C, outer surfaces 144A-C, and/or outer surfaces 146A-C may be contoured to exhibit curved (e.g., non-planar) shapes that may be parallel or non-parallel with each other. For example, FIG. 17 illustrates an embodiment of a flashlight 1700 in which bridges 1730A-B exhibit substantially curved shapes.

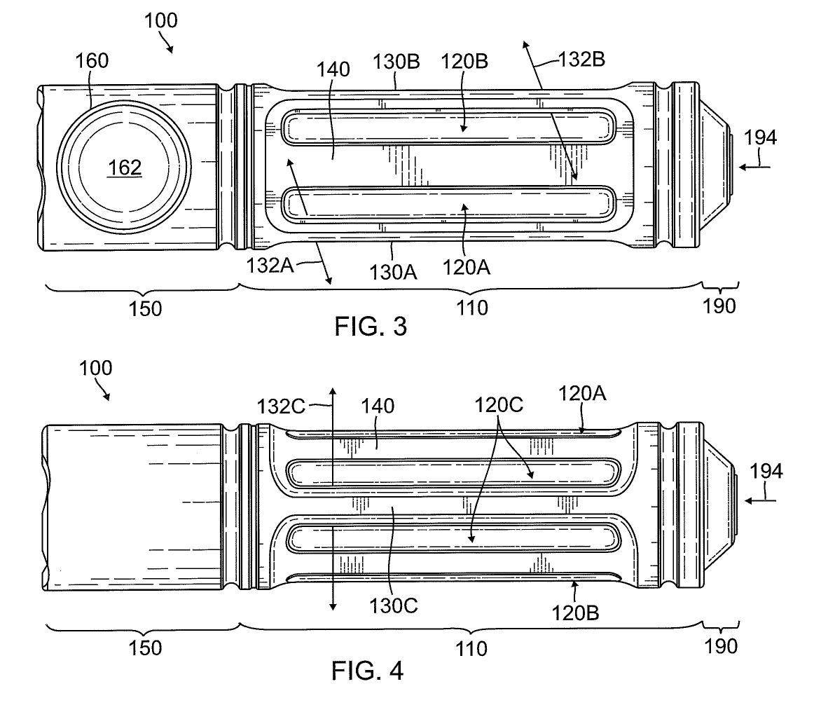

Referring again to FIGS. 1-12, a recess 160 is provided in the external surface of head 150. By comparing FIGS. 1, 3, 5, and 6, it is apparent that recess 160 exhibits a substantially circular shape (e.g., see top plan view of FIG. 3) which curves around a portion of head 150 (e.g., see FIGS. 1, 5, and 6). Upon inspection of such figures, it will be appreciated that an inner surface 162 of recess 160 is substantially contoured. In other embodiments, recess 160 may be implemented using other shapes (e.g., rectangles, squares, circles, ovals, or other shapes).

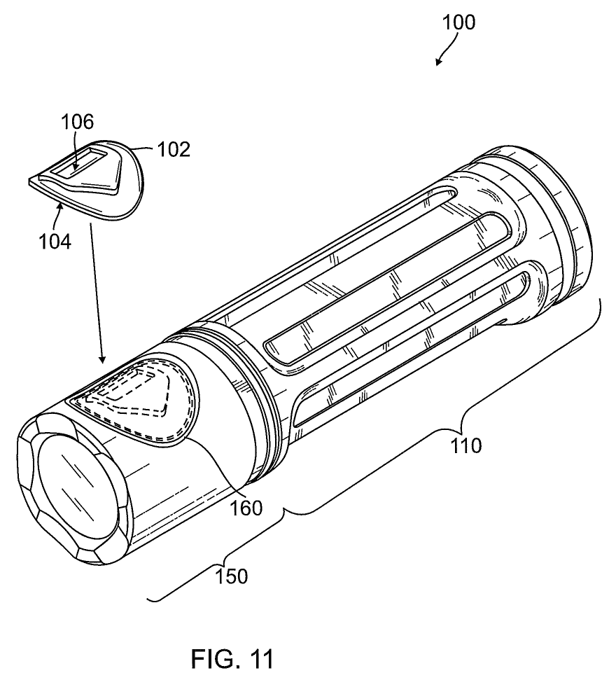

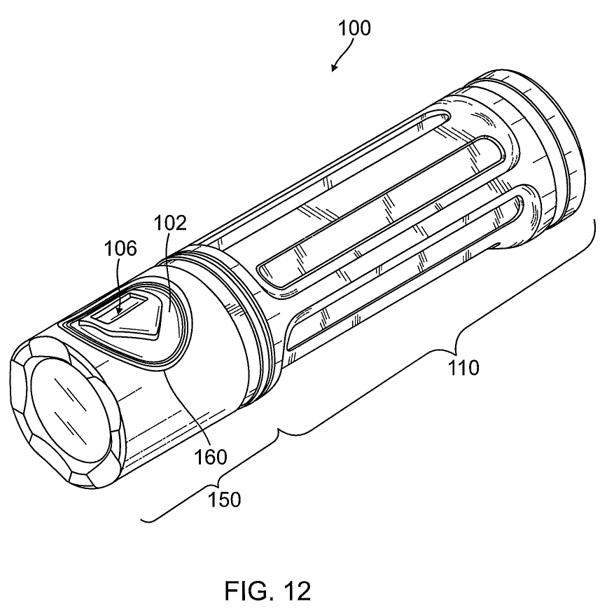

Recess 160 is adapted to receive any appropriate structure which a user or manufacturer may desire to secure to head 150. For example, in one embodiment, recess 160 may be configured to receive a plate 102. As shown in FIG. 11, plate 102 may be adapted to be inserted into recess 160. In this regard, a back surface 104 of plate 102 may be implemented with substantially contoured shape that follows the corresponding contoured shape of inner surface 162 of recess 160. As a result, back surface 104 of plate 102 may be put in contact with inner surface 162 of recess 160 such that substantially the entire back surface 104 of plate 102 contacts inner surface 162 of recess 160. FIG. 12 illustrates flashlight 100 after plate 102 has been inserted into recess 160. In various embodiments, back surface 104 of plate 102 may be affixed or otherwise secured to inner surface 162 of recess 160 using any appropriate product such as, for example, adhesive, glue, or other products. In one embodiment, the use of the previously described complementary contoured shapes for back surface 104 and inner surface 162 can facilitate the securing of plate 102 to head 150. In this regard, it will be appreciated that the contoured shapes of back surface 104 and inner surface 162 permit plate 102 to effectively wrap partially around head 150. As a result, this arrangement can provide more reliable adhesion than if such surfaces were substantially planar.

In one embodiment, plate 102 exhibits a depth approximately equal to a depth of recess 160 (e.g., approximately 1 mm). As a result, plate 102 may lie substantially flush with the outer surface of head 150 after being inserted into recess 160. Advantageously, such an embodiment can permit plate 102 to be placed in recess 160 without interfering with a user's operation of flashlight 100. It will be appreciated that recess 160 and plate 102 (or other appropriate structures) may be implemented using any desired depth. As shown in FIGS. 11 and 12, plate 102 may include letters, symbols, and/or other appropriate insignia on its top surface 106 which remain visible when plate 102 is inserted into recess 160. Advantageously, the use of recess 160 and plate 102 can permit a manufacturer or user to attach any desired type of plate 102 as may be desired in various applications.

It is contemplated that other structures (e.g., hooks, loops, or other appropriate structures) may be inserted into recess 160 to facilitate securing such structures to head 150. Similar to plate 102, such other structures may be implemented with complementary back surfaces that follow the corresponding contoured shape of inner surface 162 of recess 160. As a result, a variety of different useful features may be selectively added to flashlight 100 through appropriate attachment of such structures to recess 160 of flashlight 100.

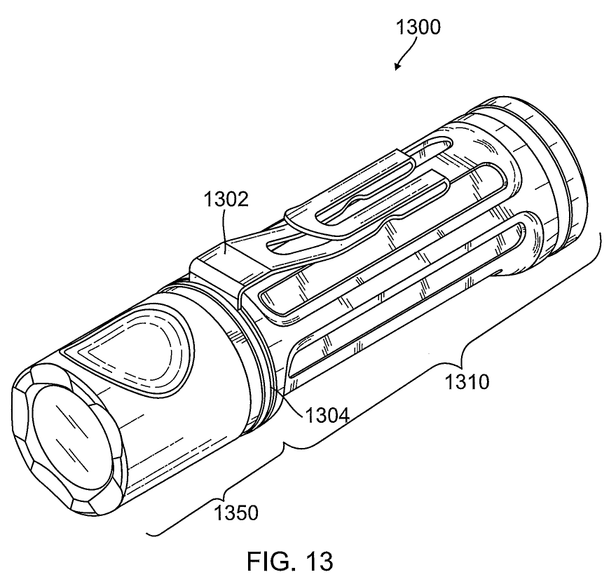

FIGS. 13-17 illustrate flashlights with additional features in accordance with various embodiments of the invention. For example, FIG. 13 illustrates a flashlight 1300 that includes the features of flashlight 100 and also includes a clip 1302. In one embodiment, clip 1302 may be secured to flashlight 1300 through an appropriate ring 1304 located between body 1310 and head 1350. Advantageously, clip 1302 may be used to secure flashlight 1300 to a user's clothing or another appropriate structure.

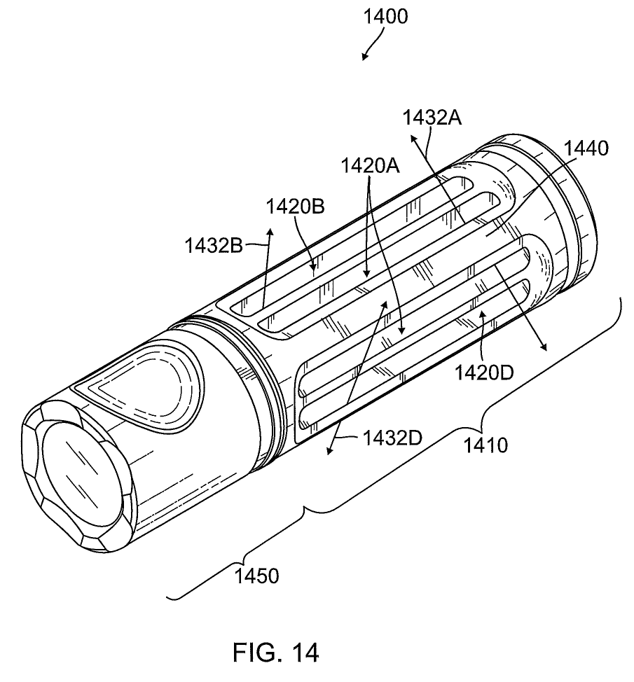

FIG. 14 illustrates a flashlight 1400 similar to flashlight 100, but with four apertures 1420A-D spaced substantially equidistantly around a core 1440. In this regard, apertures 1420A-B and D are shown extended through a body 1410 (which is connected to a head 1450), and aperture 1420C (not shown) is present on the reverse side of flashlight 1400. Apertures 1420A-B and D are shown extended along axes 1432A-B and D, and it will be appreciated that aperture 1420C may extend along its own corresponding axis 1432C (not shown).

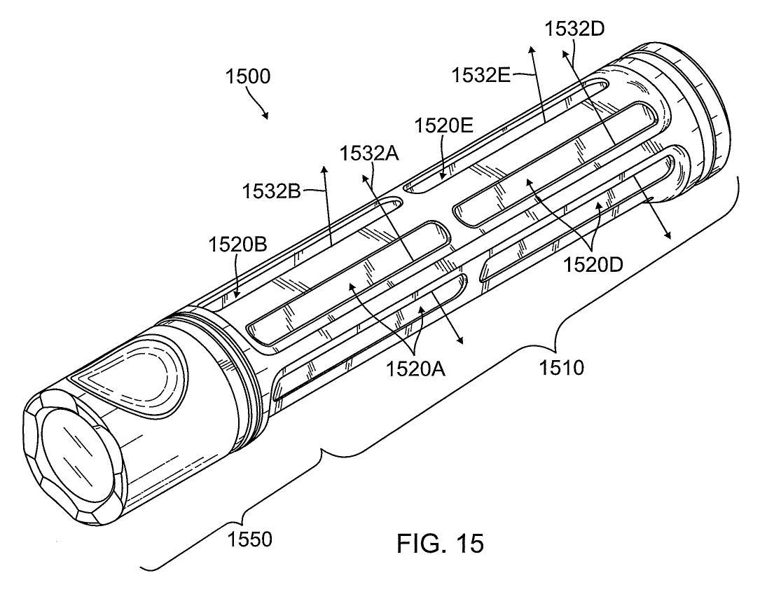

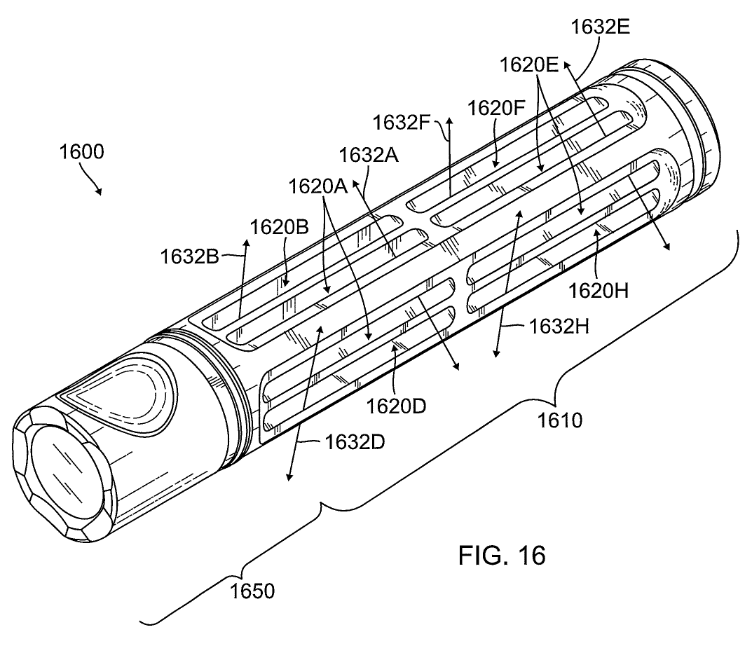

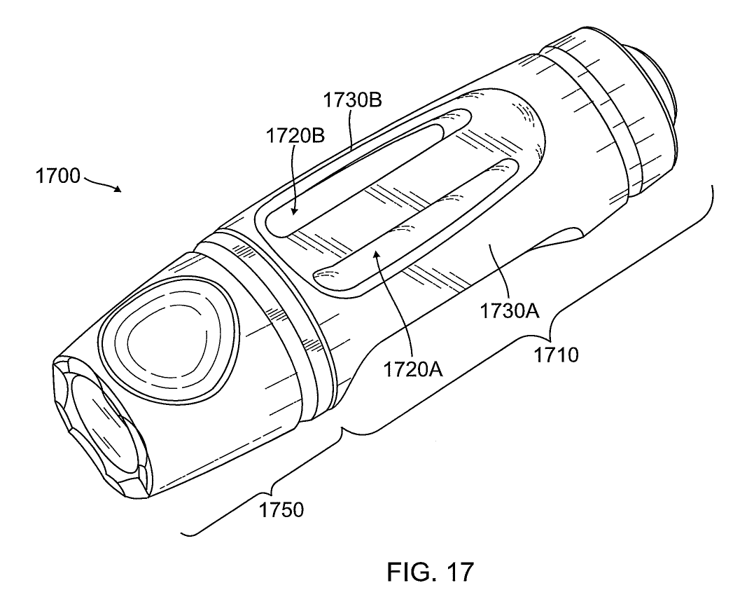

FIGS. 15 and 16 illustrate flashlights 1500 and 1600 which are elongated embodiments of flashlights 100 and 1400, respectively. In one embodiment, flashlights 1500 and 1600 may be provided with appropriate cavities (e.g., similar to cavity 112 previously discussed) which are adapted to receive two AA batteries connected in series.

As shown in FIG. 15, flashlight 1500 includes two sets of apertures 1520A-C and 1520D-F. Each set may be implemented in the manner of apertures 120A-C previously described herein. In this regard, apertures 1520A-B and 1520D-E are shown extended through a body 1510 (which is connected to a head 1550) along axes 1532A-B and 1532D-E, and apertures 1520C and 1520F (not shown) are present on the reverse side of flashlight 1500 and may extend along their own corresponding axes 1532C and 1532F (not shown).

Flashlight 1600 includes two sets of apertures 1620A-D and 1620E-H. Each set may be implemented in the manner of apertures 1420A-D of FIG. 14. In this regard, apertures 1620A-B and D and 1620E-F and H are shown extended through a body 1610 (which is connected to a head 1650) along axes 1632A-B and D and 1632E-F and H. Apertures 1620C and 1620G are present on the reverse side of flashlight 1600 and may extend along their own corresponding axes 1632C and 1632G (not shown).

As previously described, FIG. 17 illustrates another embodiment in which flashlight 1700 exhibits various curved shapes. In this regard, flashlight 1700 includes a body 1710 and a head 1750, each of which exhibits a substantially curved shape. As previously described, bridges 1730A-B also exhibit a substantially curved shape. In addition, flashlight 1700 includes apertures 1720A-B that exhibit contoured shapes that differ from other apertures discussed herein. It will be appreciated that, similar to other embodiments shown in FIGS. 1 and 15, an additional aperture 1720C and an additional bridge 1730C (not shown) may be provided on the reverse side of flashlight 1700. Advantageously, the contoured shape of flashlight 1700 can provide a comfortable shape for a user's hand to grip flashlight 1700.

In view of the present disclosure, it will be appreciated that various structures are provided which may be advantageously used in one or more flashlights. For example, as discussed above, the inclusion of various apertures in a flashlight body can facilitate attachment of the flashlight with various structures. In addition, the inclusion of a recess in a flashlight head can be used to facilitate the attachment of appropriate insignia or structures to a flashlight in an efficient manner that need not interfere with a user's operation of the flashlight.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. For example, it is contemplated that the various embodiments set forth herein can be combined together and/or separated into additional embodiments where appropriate.

Having thus described embodiments of the present invention, persons of ordinary skill in the art will recognize that changes may be made in form and detail without departing from the scope of the invention. Thus the invention is limited only by the following claims.

What is claimed is:

1. A flashlight comprising:
a body comprising a core and a plurality of bridges; and
a plurality of apertures extended through the body, wherein each aperture offsets a corresponding one of the bridges from the core, wherein each aperture is adapted to receive an external object inserted through the body under a corresponding one of the bridges.

2. The flashlight of claim 1, wherein the body comprises a metal material.

3. The flashlight of claim 1, wherein the body comprises a polymer material.

4. The flashlight of claim 1, wherein the core and the bridges of the body comprise a single component.

5. The flashlight of claim 1, wherein the apertures are elongate apertures that extend lengthwise along the body.

6. The flashlight of claim 1, wherein each aperture is adapted to receive a mounting apparatus adapted to secure the flashlight to an external structure.

7. The flashlight of claim 1, wherein each aperture is adapted to receive a flexible structure adapted to be wrapped around at least one of the bridges.

8. The flashlight of claim 1, wherein the bridges extend lengthwise down the body and are substantially parallel to each other.

9. The flashlight of claim 1, wherein the bridges have substantially curved shapes.

10. The flashlight of claim 1, wherein the core comprises a plurality of substantially planar outer surfaces, wherein the bridges comprise a plurality of substantially planar inner surfaces parallel to corresponding outer surfaces of the core.

11. The flashlight of claim 1, wherein the apertures comprise three apertures spaced substantially equidistantly around the core.

12. The flashlight of claim 1, wherein the apertures comprise a first set of three apertures spaced substantially equidistantly around a first portion of the core, and a second set of three apertures spaced substantially equidistantly around a second portion of the core.

13. The flashlight of claim 1, wherein the apertures comprise four apertures spaced substantially equidistantly around the core.

14. The flashlight of claim 1, wherein the apertures comprise a first set of four apertures spaced substantially equidistantly around a first portion of the core, and a second set of four apertures spaced substantially equidistantly around a second portion of the core.

15. The flashlight of claim 1, further comprising a cavity in the core, wherein the cavity is adapted to receive a battery to power the flashlight.

16. The flashlight of claim 1, further comprising a tailcap adapted to be secured to the body and adapted to be pressed by a user to operate the flashlight.

17. The flashlight of claim 1, further comprising:
a head adapted to be secured to the body of the flashlight; and
a recess in an external surface of the head, wherein an inner surface of the recess is adapted to receive a structure to be secured to the head.

18. A flashlight comprising:
a head adapted to be secured to a body of the flashlight; and
a recess in an external surface of the head, wherein an inner surface of the recess is adapted to receive a structure to be secured to the head.

19. The flashlight of claim 18, wherein the recess has a depth of approximately 1 mm.

20. The flashlight of claim 18, wherein the recess curves around a portion of the head.

21. The flashlight of claim 18, wherein the recess has a substantially circular shape.

22. The flashlight of claim 18, further comprising the structure inserted into the recess and secured to the head.

23. The flashlight of claim 22, wherein the structure comprises a back surface, wherein the back surface of the structure and the inner surface of the recess have complementary contoured shapes.

24. The flashlight of claim 23, wherein substantially the entire back surface of the structure contacts the inner surface of the recess.

25. The flashlight of claim 22, wherein the structure has a depth approximately equal to a depth of the recess such that the structure is substantially flush with the external surface of the head.

26. The flashlight of claim 22, wherein the structure is a plate comprising an insignia that is visible while the plate is inserted into the recess.

27. The flashlight of claim 22, wherein the structure is a hook adapted to attach the flashlight to another structure.

28. The flashlight of claim 22, wherein the structure is a loop adapted to attach the flashlight to another structure.

29. The flashlight of claim 18, further comprising:
the body, wherein the head is secured to the body, wherein the body comprises a core and a plurality of bridges; and
a plurality of apertures extended through the body, wherein each aperture offsets a corresponding one of the bridges from the core, wherein each aperture is adapted to receive an external object inserted through the body under a corresponding one of the bridges.

30. A flashlight comprising:
a body comprising a core and a plurality of bridges;
a plurality of apertures extended through the body, wherein each aperture offsets a corresponding one of the bridges from the core, wherein each aperture is adapted to receive an external object inserted through the body under a corresponding one of the bridges;
a head secured to the body;
a recess in an external surface of the head, wherein an inner surface of the recess is adapted to receive a structure to be secured to the head; and
a tailcap secured to the body.
